(19) United States
(12) Patent Application Publication
(10) Pub. No.: US 2019/0318131 A1
(43) Pub. Date: Oct. 17, 2019

(54) METHODS AND SYSTEM FOR HIGH VOLUME PROVISIONING PROGRAMMABLE LOGIC DEVICES WITH COMMON AND UNIQUE DATA PORTIONS

(71) Applicant: Akamai Technologies, Inc., Cambridge, MA (US)

(72) Inventor: Marin S. Lulic, Cambridge, MA (US)

(73) Assignee: Akamai Technologies, Inc., Cambridge, MA (US)

(21) Appl. No.: 15/955,530

(22) Filed: Apr. 17, 2018

Related U.S. Application Data
(63) Continuation of application No. 15/954,865, filed on Apr. 17, 2018.

(51) Int. Cl. G06F 21/76; H04L 9/08; G06F 21/57

(52) U.S. Cl. CPC G06F 21/76; G06F 21/57; H04L 9/0894

(57) ABSTRACT

Among other things, this document describes systems, devices, and methods for responding to the detection of tampering with a remotely deployed computer, such as a server in a network data center. In one embodiment, the computer can be equipped with various tamper detection mechanisms, such as proximity sensors or circuitry triggered when the server's case is opened and/or internal components are moved or altered. Tamper detection can invoke an automated trust revocation mechanism. When tampering is detected, the computer hardware can automatically prevents access to, and/or use of, a previously stored authentication key. Consequently, the computer cannot authenticate to a remote entity, such as a network operations center and/or another computer in a distributing computing system. In some embodiments, the computer remains operable so that administrators can communicate with the server and/or extract information therefrom, although the computer will be treated as entrusted.

### BACKGROUND

### Technical Field

This application relates generally to methods, system, and apparatus for responding to the detection of tampering of a computer, and in particular a remotely deployed computer.

### Brief Description of the Related Art

Cloud service platforms, enterprises, and even individuals increasingly rely on computer hardware that is outside of their physical control. A rack of servers in a data center may be physically managed by a telecommunications operator, network access provider, data center subcontractors, or other third party entities. The server owner, and/or server tenant, may access, configure, and utilize these servers remotely, whether over the Internet or otherwise. The physical security of these computers is of crucial concern to their owners and users, as they may be used to process and/or store authenticators, personal information, secrets, or other sensitive information. An attacker with physical control of the computer might be able to extract such information, or use the computer to extract data from other entities in the network that trust the computer.

Monitoring and reacting to potential tampering of computer hardware is challenging in light of the massive scale of many modern day computing platforms. Large cloud service providers, such as content delivery networks (CDNs), may have hundreds of thousands of deployed servers in thousands of networks. Furthermore, deployments are continually changing.

It is desirable to effectively detect and react to tampering by removing access to the computer itself, but from the point of view of the network, there is also a desire to automatically isolate and exclude compromised servers from interacting with other parts of the platform. There is also a desire to be able to remotely diagnose and mitigate the breach, and perhaps even continue to communicate with or gain intelligence from the breached computer.

The teachings hereof address—among other things—the technical problem of information security as relates to remotely deployed computers, and therefore improves the operational utility of the computer itself as well as any larger computing platform to which it is connected.

### BRIEF SUMMARY

Among other things, this document describes systems, devices, and methods for responding to the detection of tampering with a remotely deployed computer, such as a server in a network data center. In one embodiment, the computer can be equipped with various tamper detection mechanisms, such as proximity sensors or circuitry triggered when the server's case is opened and/or internal components are moved or altered. Tamper detection can invoke an automated trust revocation mechanism. When tampering is detected, the computer hardware can automatically prevents access to, and/or use of, a previously stored authentication key. Consequently, the computer cannot authenticate to a remote entity, such as a network operations center and/or another computer in a distributing computing system. In some embodiments, the computer remains operable so that administrators can communicate with the server and/or extract information therefrom, although the computer will be treated as untrusted.

Preferably, through without limitation, the computer hardware is configured such that the authentication key unavailable not only for the computer itself to use, but also unavailable to an individual with physical access to the computer hardware (e.g., an individual tampering with the computer). In some embodiments, this is achieved by storing the authentication key in encrypted format, potentially along with other data, such that neither the clear-text nor the encrypted form of the authentication key is available locally.

In some embodiments, a computer provides a tamper detection component that detects the occurrence of a particular event, such as the removal of the cover of the computer. The computer further provides a mechanism that switches the data set used to operate the computer. In one embodiment, the computer switches from a trusted operational mode (e.g., by having access to an authentication key) to an untrusted operational mode. In other embodiments, the computer switches from a first set of data to a second set of data, e.g., by virtue of being unable to read the first set of (encrypted) data and the encryption key being inaccessible or removed. The first set of data may include a first set of firmware or software instructions and the second set of data may include a set of firmware or software instructions, thereby providing differing functionality. The first set can include the routines or keys necessary to authenticate to a network operations center, while the second set does not. Further the second set can include routines to report to a network operations center about the circumstances of detected tampering, e.g., time and day, which sensor was tripped, current location of the computer, etc.

The foregoing is a description of certain aspects of the teachings hereof for purposes of illustration only; it is not a definition of the invention. The claims define the scope of protection that is sought, and are incorporated by reference into this brief summary.

### BRIEF DESCRIPTION OF THE DRAWINGS

The invention will be more fully understood from the following detailed description taken in conjunction with the accompanying drawings, in which:

FIG. 1 is a logical diagram illustrating a computer and selected components therein, in one embodiment;

FIG. 2 is a diagram illustrating one embodiment of the tamper response circuitry shown in FIG. 1;

FIG. 3 is a diagram illustrating one embodiment of a distributed computing system of which the computer 100 that is shown in FIG. 1 is a member;

FIG. 4 is a diagram illustrating an alternate to the tamper response circuitry shown in FIG. 2;

FIG. 5 is a block diagram illustrating hardware in a computer system that may be used to implement the teachings hereof, with the tamper response circuitry shown in FIG. 2; and

FIG. 6 is a block diagram illustrating hardware in a computer system that may be used to implement the teachings hereof, with the tamper response circuitry shown in FIG. 4.

### DETAILED DESCRIPTION

The following description sets forth embodiments of the invention to provide an overall understanding of the principles of the structure, function, manufacture, and use of the methods and devices disclosed herein. The systems, methods and apparatus described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different machines in a variety of ways.

4

Any description of advantages or benefits refer to potential advantages and benefits that may be obtained through practice of the teachings hereof. It is not necessary to obtain such advantages and benefits in order to practice the teachings hereof.

Basic familiarity with well-known web page, streaming, and networking technologies and terms, such as HTML, URL, XML, AJAX, CSS, HTTP versions 1.1 and 2, TCP/IP, and UDP, is assumed. The term “server” is used herein to refer to hardware (a computer configured as a server, also referred to as a “server machine”) with server software running on such hardware (e.g., a web server). In addition, the term “origin” is used to refer to an origin server. Likewise, the terms “client” and “client device” is used herein to refer to hardware in combination with software (e.g., a browser or player application). While context may indicate the hardware or the software exclusively, should such distinction be appropriate, the teachings hereof can be implemented in any combination of hardware and software.

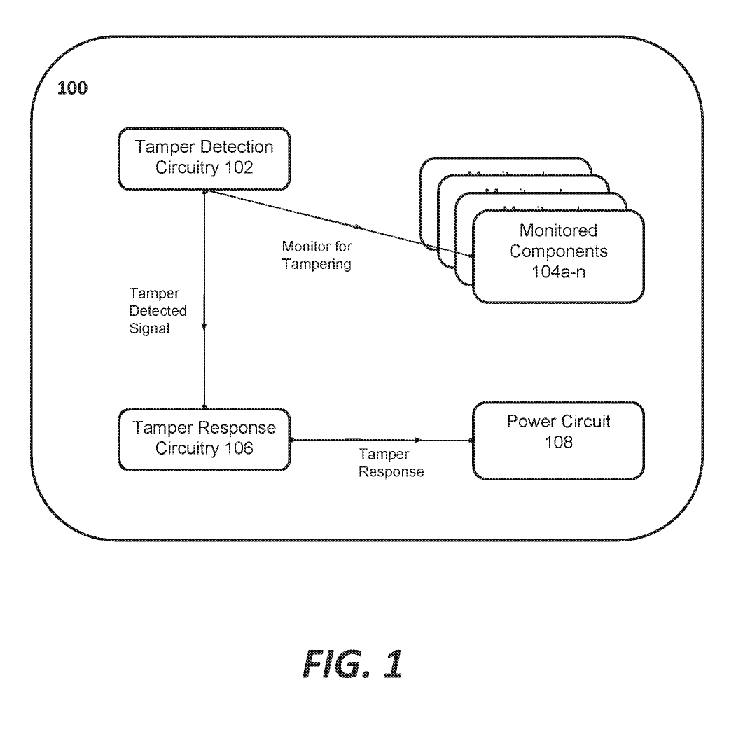

FIG. 1 depicts a computer 100 and certain components therein. It should be understood that FIG. 1 does not necessarily depict all components in the computer, and that FIG. 1 is a logical diagram and illustrates the functional relationships between selected components of the computer 100 at a high level. In one embodiment, computer 100 is a content server in a content delivery network such as that provided by Akamai Technologies Inc., although this is not a limitation of the teachings hereof. Information about content delivery networks (CDNs) can be found in U.S. Pat. Nos. 6,108,703, 7,240,100 and 9,634,957, all of which are hereby incorporated by reference in their entireties and for all purposes.

With reference to FIG. 1, tamper detection circuitry 102 monitors one or more components 104a-n for evidence of tampering. The monitored components 104a-n may include circuit boards—including the motherboard—of the computer as well a top cover or other portions of the computer enclosure. There may be a wide range of monitored components, and the tamper detection circuitry 102 may be implemented in a wide variety of ways. Merely by way of example, the tampering detection circuitry 102 may include any of the following, without limitation:
A proximity sensor, such as an optical or magnetic sensor, mounted within the computer to detect removal of the cover by detecting the change in distance from the sensor to the cover.
A proximity sensor mounted on the motherboard, or other circuit board, to detect removal thereof by detecting a change in distance from the circuit board to a another object (e.g., a neighboring component and/or portion of the enclosure). For example, a sensor mounted on the bottom of the motherboard and calibrated to the distance between the motherboard and the bottom of the computer enclosure can detect when the motherboard is lifted upwards.
A temperature sensor and associated circuits to detect a drop in temperature, e.g., as used in a cold-boot attack.
An electrical circuit formed in part by screw posts and screws that are used to secure computer components (such as the circuit boards) within the computer. Such a circuit can detect tampering, e.g. removal of a component, when the screw is removed from the screwpost, creating an open circuit condition. See, e.g., U.S. Pat. No. 6,512,454, the teachings of which are hereby incorporated by reference.

Tampering detection circuitry 102 can monitor each of these individual monitoring circuits and in effect multiplex them together so that a master tamper detection signal is raised when any one is triggered.

As shown in FIG. 1, the tamper detection signal is received by tamper response circuitry 106. In this embodiment, the tamper response circuitry 106 responds by cutting power to certain components, e.g., to disable the components or remove data therefrom. This is shown by the connection to power circuit 108, which powers certain components in the computer. More details about the removal of power and its consequences will be described below and in connection with later Figures. However, it should understood that the embodiments described herein are merely examples tamper responses and that the teachings hereof can be employed in a variety of ways to achieve a variety of unique tamper responses, as will become apparent.

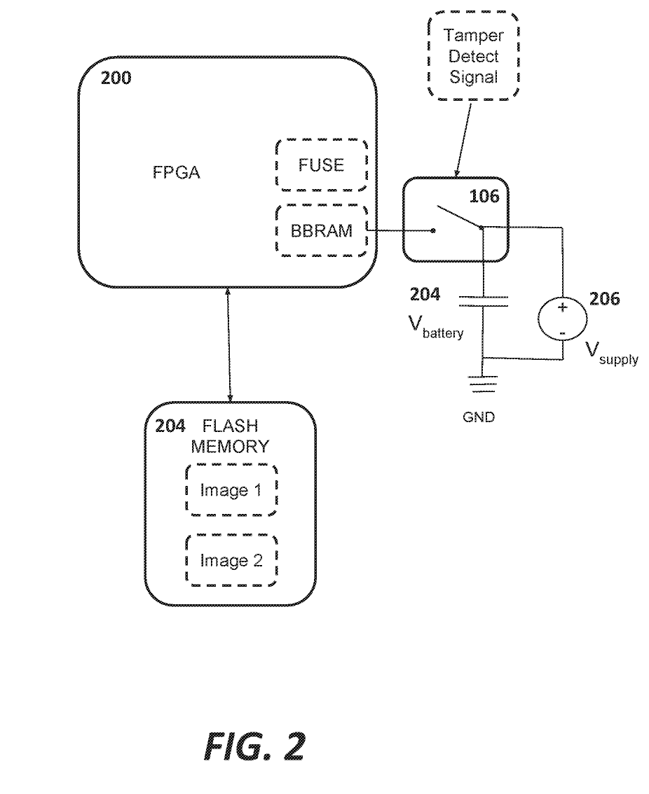

FIG. 2 is a block diagram of tamper response circuitry 106, in one embodiment. The field programmable gate array (FPGA) 200 and other components shown in FIG. 2 may be placed on the motherboard of the computer 100, or other circuit board therein. The FPGA may be programmed to perform functions other than the tamper-related functions described herein. For example, the FPGA might be programmed to provide board controller functions (e.g., processor startup, power management), BIOS verification for integrity and/or security purposes, as well as any custom functionality desired.

FPGA 200 can be implemented using a commercially available re-programmable logic device from vendors such as Xilinx®. As known in the art, Xilinx FPGAs contain BBRAM and a FUSE memory registers. The BBRAM is volatile and powered by a battery backup 204, which is subject to being disconnected at switch 106, upon detection of potential tampering. The FUSE memory is nonvolatile.

Flash memory 204 contains data in the form of configuration files used to configure the FPGA. In this case there are two configurations denoted as Image 1 and Image 2. As known in the art, upon startup the Xilinx FPGA is loaded with a configuration file that programs the device to operate as intended. The configuration file configures the logic circuitry of the FPGA to provide a FPGA user's desired operations/functions. Multiple such configuration files may be stored in the flash memory 204 and a ‘jump table’ is used essentially as a directory to specify where each configuration can be found in the flash memory 204; this can be used to specify that Image 1 should load or Image 2 should load, etc.

Xilinx FPGAs also provide a built-in encryption capability to secure and protect the designs reflected in the configuration file(s). It works as follows: an encryption key is generated by the user and stored in BBRAM or FUSE memory; once loaded it cannot be read back from the FPGA, although the FPGA can access the key internally. The encryption key is in addition used to encrypt the configuration file (e.g., Image 1) using a cryptographic algorithm (AES with 256 bit keys). The configuration file is stored encrypted in the flash memory. At startup, the encrypted configuration file is loaded into the FPGA, and the FPGA is uses the stored encryption key to decrypt the bitstream as it is loaded into the FPGA, allowing the FPGA to be properly configured.

In accordance with the teachings hereof, Image 1 and Image 2 both can be stored in the flash memory 204 as part of manufacturing and deployment of the computer 100. Image 1 contains an authentication key, potentially among other things, and this authentication key is preferably unique to the computer 100. Image 1 is encrypted using an encryption key stored in BBRAM, which is powered by a battery backup 204 (as well as the computer's power supply 206). Image 1 may also contain other information such as configuration data necessary to configure the FPGA to function as a motherboard controller, or otherwise, as previously mentioned. Image 2 can contain a similar configuration to Image 1, except that it lacks the authentication key. Image 2 is preferably encrypted in accord with the default value of the FUSE register, typically zeros. Put another way it is a “dummy” encryption key. Alternatively, the Image 2 can be stored unencrypted. However, some FPGAs do not permit some configurations in flash memory 204 to be encrypted and others to be unencrypted; rather if Image 1 is to be encrypted, Image 2 must also be encrypted. The startup logic of the FPGA and jump table is configured such that the Image 1 is initially selected for loading using the encryption key stored in BBRAM, and if that fails, Image 2 is loaded using the encryption key in FUSE.

The operation of the tamper response circuitry in FIG. 2 will now be described.

Upon receipt of a tamper detection signal, switch 106 is thrown to remove both the battery power 204 connection and the power supply 2-6 connection to the BBRAM of the FPGA. In some embodiments, the switch only controls the connection to the battery 204. This arrangement can still work because most tamper detection takes place when the computer 100 is unplugged, so the power supply is inactive and the BBRAM is relying solely on the battery for power.

The removal of power to the volatile BBRAM causes the stored encryption key to be lost. When the computer 100 is re-started, the FPGA will attempt to load image 1 according to the jump table. But the attempt to load Image 1 will fail, because the FPGA will not have the necessary encryption key to decrypt Image 1. The FPGA will then attempt to load image 2, using the jump table. Because Image 2 is either unencrypted (if possible) or encrypted according to the default state of FUSE, the FPGA will be able to decrypt Image 2, load it into the FPGA, and the FPGA will be able to function as a board controller or otherwise as configured to help run the computer 100.

At some point after Image 2 is loaded, assume that the computer 100 needs to authenticate to a remote entity. Assume, for example, that the computer 100 is part of a distributed computing system and attempts to join the network or otherwise announce its availability. The distributed system can require that the computer 100 provide the authentication key. This can be done in any of wide range of ways, such as an automated challenge from another computer in the system, or instituted manually by a system administrator in a network operations center upon seeing the computer 100 announce its liveness.

Because Image 2 is loaded rather than Image 1, the computer 100 will not be able to use the valid authentication key assigned to the computer 100. For example, the network can require the computer 100 to authenticate with an HMAC message (key-hashed message authentication code) sent to the network operations center, which will be validated there (one can assume that the network operations center has the necessary key corresponding to computer 100 for validation purposes). However, if the computer 100 does not have the authentication key (the authentication key necessary to compute the HMAC) it cannot generate the proper HMAC message. The authentication will fail, and the computer 100 can be excluded from joining the system. However, at least in some embodiments, the network operations center or other entity may nevertheless continue to communicate with the computer 100. Such communications would be entrusted.

In some embodiments, Image 2 differs from Image 1 not only in that it lacks an authentication key but also in that it contains reporting logic that will (upon configuration and operation of the FPGA) communicate certain diagnostic and forensic information to a network operations center. Hence, when tampering is detected and Image 2 is activated, such reporting logic can execute to log and report things such as the identity of the tampering circuit that was tripped, computer location information, and other state information. The Image 2 functionality could also cause the FPGA to log commands that an intruder attempts to execute on the computer, e.g., by capturing peripheral bus user input, monitoring processor bus operations, or the like. Such operations may run automatically upon deployment of Image 2's logic in the FPGA without waiting for a query for the information from a network operations center. In this way, the tampered computer 100 can in effect transmit a tamper reporting beacon with relevant information, possibly to a predefined IP address.

It should also be understood that the use of the authentication key stored Image 1 is but one example. Image 1 could contain any kind or form of authenticator in addition to (or alternatively), whether described as a token, credential, or otherwise. In some embodiments, Image 1 contains logic necessary to respond correctly to a logical authentication challenge perform a designated operation and provide the result) issued by the network operations center.

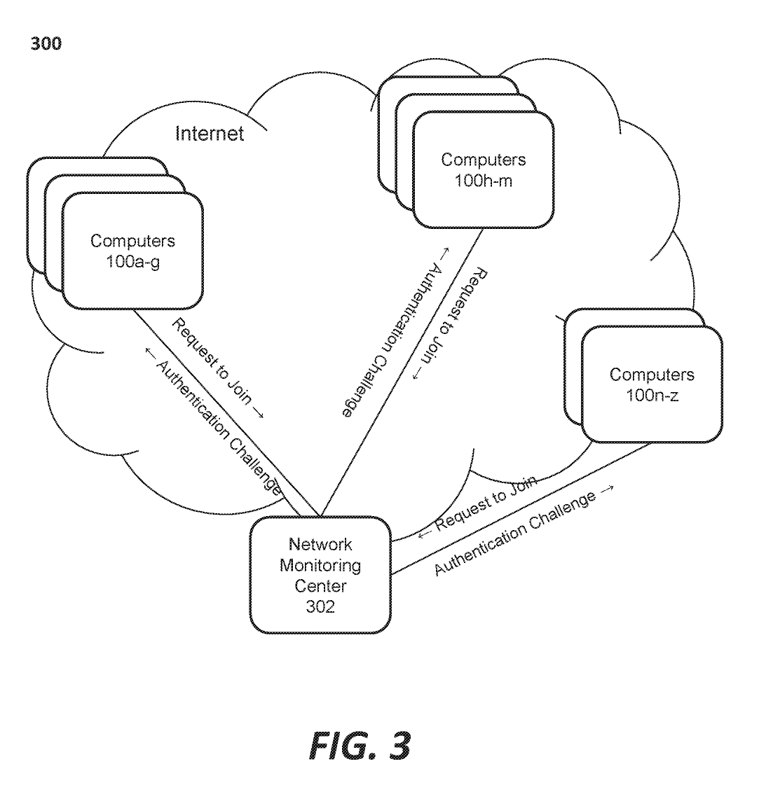

FIG. 3 is a block diagram illustrating the notion (already mentioned above) that many computers 100a-z with tamper detection circuitry may be part of a larger distributed system 300 deployed in a variety of networks around the world and interconnected via the Internet. Also depicted is a network operations center 302 that issues or requires authentication before allowing a computer 100 to join the system.

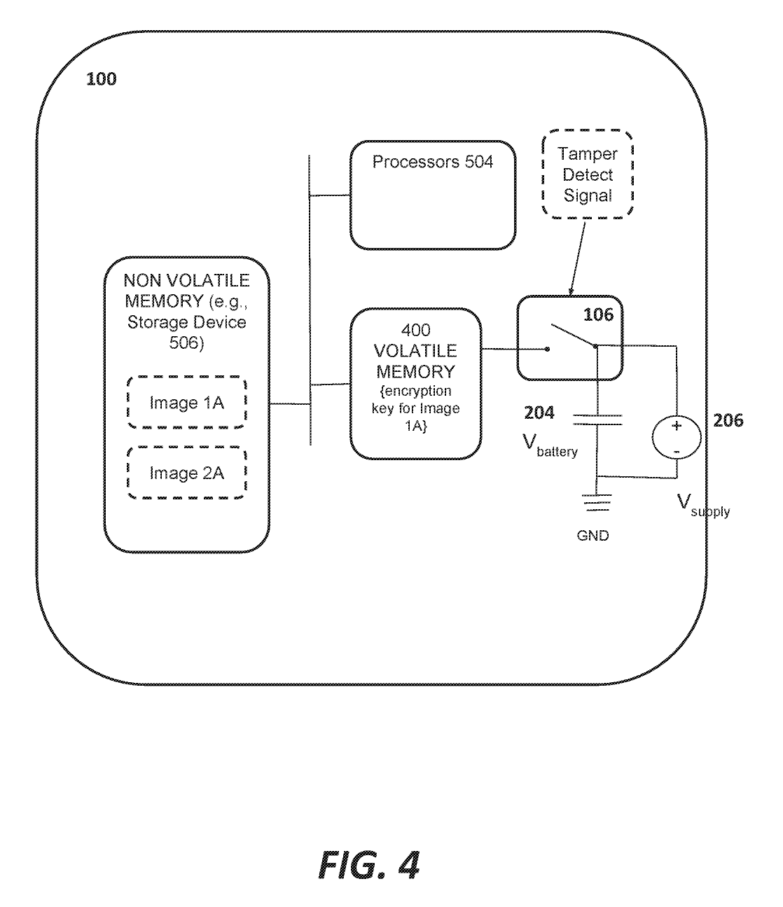

FIG. 4 is a block diagram of an alternate embodiment of the invention. More specifically, FIG. 4 is an alternate to FIG. 2. In this embodiment, the encryption key is stored in volatile memory 400. Also shown are Images 1A and 2A. The data in Image 1A represents the data to be used in normal operation, while Image 2A represents the data to be used once tampering is detected.

The encryption key stored in volatile memory 400 is used to encrypt image 1A, which is a first set of data stored in computer 100. Image 1A may include an authentication key and/or a first set of computer program instructions. Image 1A may be stored in on hard disk, solid state storage drive, dedicated flash memory, EEPROM, or otherwise. Image 2A represents a second set of data stored in computer 100; it may be stored in the same or different device as Image 1A. FIG. 4 depicts both Image 1A and Image 2A stored in the same device although this is not necessary. Image 2A is unencrypted. Or, Image 2A is encrypted with a second encryption key other than the one stored in 400; the second encryption key can be stored in nonvolatile memory, for example.

Operation of the embodiment shown in FIG. 4 proceeds similarly to that in FIG. 2. Upon detection of tampering, power to the volatile memory 400 is removed by switch 106, causing the encryption key stored therein to be lost. Subsequently, and after restart, the computer 100 (eg., via execution of software instructions on processors 504) attempts to authenticate to a system 300. To do this it attempts to access the data in Image 1A; however, access to Image 1A fails because it cannot be decrypted as the encryption key for Image 1A is no longer available. Hence, image 2A is used, as this is unencrypted (or encrypted according to another key which is available). The logic of first trying Image 1A and then upon failure switching to use Image 2A can be implemented in software, in this embodiment.

Remote Disable of the Tamper Response Circuitry

In one embodiment, the tamper response mechanism can be disabled from a remote network operations center. To accomplish this, there is a simple battery-backed chip that “arms” all the tamper response circuitry, e.g., including in particular switch 106. The computer 100 leaves the manufacturing floor (deemed as a safe haven) in an armed state. The tamper detection system can catch intrusion at points after that (shipping, storage, rack-mount, etc.). Presuming no intrusion has taken place, the network operations center places trust in the machine and it begins operation. If maintenance is required of computer 100, the network operations center (though a secure network connection to the computer) “disarms” the tamper response circuitry, preferably via software commands, which disables the switch 106 from cutting power. Once disarmed, a field technician can remove the cover for maintenance without destroying any keys, as the switch 106 has been de-activated. Once maintenance is complete, the computer 100 is brought back online, the network operations center can put trust back into the computer 100 and enables the arming circuitry once again.

Programming and Provisioning of Unique Authentication Keys

In embodiments described above, an programmable logic device such as an FPGA is used as part of the system, with Image 1 holding an authentication key unique to the computer 100. While use of an FPGA is not necessarily required to take advantage of the teachings hereof, now described is a way of inserting a unique key into an FPGA design.

An FPGA design is typically implemented by creating a design in source code and from that generating (using the FPGA manufacturer's tools) a binary configuration file, which is the Image 1 or other image stored in the memory 204. The generation of the configuration file involves validating the design and conducting a place & route process for the FPGA. The unique key makes each design effectively a unique design which must be individually placed and routed; however, doing the place and route repeatedly (with small differences for the key) is extremely time-consuming and also tends to reduce confidence in the validated design.

To overcome these obstacles, the teachings hereof include a method of programming a unique key into a programmable logic device such as an FPGA, during the manufacturing process for the computer 100. The result of this process is the programming of a unique string of bits into each design, while keeping the majority of the binary configuration file the same across chips. Put another way, the result of the process is a large number of configuration files with a common portion but each having a unique portion (e.g., the unique authentication key). These files can be then be loaded into the memories 204 of each computer 100 during manufacturing.

The process can be performed leveraging Xilinx FPGAs and chip programming tools provided by Xilinx, along with the teachings hereof.

An embodiment of the process is:
1) Generate a binary which will be the master configuration file for the design, with a common portion and a unique portion. The unique portion is preferably a portion of the FPGA design that is configured to be individual blocks of random access memory (RAM). As noted above, the master configuration file is generally created upon completion of the place and route process, which in Xilinx terminology results in a .dcp file (Design Check Point).
2) With a provisioning server, for a given FPGA target, create a copy of the master configuration file.
3) The provisioning server inserts a uniquely generated authentication key into the unique portion of the master configuration file, creating a unique configuration file. The key is a small change relative to the overall size of the configuration file. This step is possible because the Xilinx process allows some manipulation of the .dcp file (i.e., master configuration file), and the manipulation can be prior to encrypting the design with the BBRAM key (encryption key). Specifically, the manipulation of the .dcp file can be accomplished by programming a unique authentication key into the block RAM portion of the FPGA design that was created at (step 1).
4) The provisioning server catalogs the authentication key and corresponding unique configuration file in a key management database.
5) The provisioning server iterates this process to create the next unique configuration file, until the complete set of all desired unique configuration files are generated and populated in the database. Preferably, all configuration files are generated before the manufacturing of the computers.
6) On the manufacturing floor, as computer units 100 are being assembled, a unique pre-generated binary (i.e., the unique configuration file) is remotely and securely retrieved from the key management database. The file is loaded into the memory 204 of the computer 100 being assembled, where it can be used to configure FPGA 200. The unique configuration file is associated with the serial numbers of the computer 100 being assembled. This means that the key management database now has a mapping between a unique authentication key, a unique configuration file, and the serial numbers of a newly built computer 100.

In this way, the place and route of the entire design does not have to be redone, saving time. The pre-generation of the binary unique configuration files saves manufacturing time because the manipulation of .dcp file (step 3 above), alone, can take minutes for each file.

In an alternate embodiment, rather than programming a unique authentication key, a portion of the FPGA logic could contain a unique (or non-unique but secret) set of logic to response to a network operations center challenge-response sequence. The teachings above could nevertheless still be used to program and provision such unique sets of data. Specifically, instead of programming a unique authentication key into the RAM portion, other data representing encoded computer program instructions can be programmed into the RAM.

The use of an FPGA or of an authentication key is not required; generalizing above, a unique portion may be stored in any kind of programmable memory device in the computer.

Computer Based Implementation

The teachings hereof may be implemented using conventional computer systems, but modified by the teachings hereof, with the functional characteristics described above realized in special-purpose hardware, general-purpose hardware configured by software stored therein for special purposes, or a combination thereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus—such as a microprocessor in a computer, digital data processing device, or other computing apparatus as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code, such as the “interpreter” referenced above.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

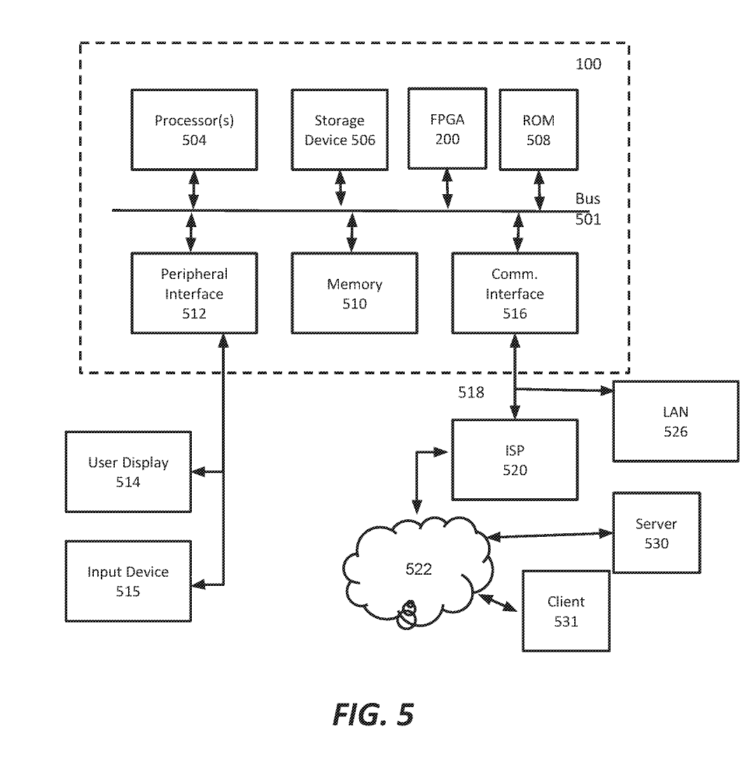

FIG. 5 provides a component level view of the computer 100 shown in FIG. 1. The FPGA 200 is shown connected to the bus 501. (Flash memory 204 is not shown in this diagram but can be connected on a back end communication channel to the FPGA 200.)

The computer system 500 may be embodied in a client device, server, personal computer, workstation, tablet computer, mobile or wireless device such as a smartphone, network device, router, hub, gateway, or other device. Representative machines on which the subject matter herein is provided may be Intel Pentium-based computers running a Linux or Linux-variant operating system and one or more applications to carry out the described functionality.

Computer system 500 includes a microprocessor 504 coupled to bus 501. In some systems, multiple processor and/or processor cores may be employed. Computer system 500 further includes a main memory 510, such as a random access memory (RAM) or other storage device, coupled to the bus 501 for storing information and instructions to be executed by processor 504. A read only memory (ROM) 508 is coupled to the bus 501 for storing information and instructions for processor 504, such as BIOS; this may interact with FPGA 200 as described herein. A non-volatile storage device 506, such as a magnetic disk, solid state memory (e.g., flash memory), or optical disk, is provided and coupled to bus 501 for storing information and instructions. Other application-specific integrated circuits (ASICs), field programmable gate arrays (FPGAs) or circuitry may be included in the computer system 500 to perform functions described herein.

A peripheral interface 512 communicatively couples computer system 500 to a user display 514 that displays the output of software executing on the computer system, and an input device 515 (e.g., a keyboard, mouse, trackpad, touchscreen) that communicates user input and instructions to the computer system 500. The peripheral interface 512 may include interface circuitry, control and/or level-shifting logic for local buses such as Universal Serial Bus (USB), IEEE 1394, or other communication links.

Computer system 500 is coupled to a communication interface 516 that provides a link (e.g., at a physical layer, data link layer) between the system bus 501 and an external communication link. The communication interface 516 provides a network link 518. The communication interface 516 may represent a Ethernet or other network interface card (NIC), a wireless interface, modem, an optical interface, or other kind of input/output interface.

Network link 518 provides data communication through one or more networks to other devices. Such devices include other computer systems that are part of a local area network (LAN) 526. Furthermore, the network link 518 provides a link, via an internet service provider (ISP) 520, to the Internet 522. In turn, the Internet 522 may provide a link to other computing systems such as a remote server 530 and/or a remote client 531. Network link 518 and such networks may transmit data using packet-switched, circuit-switched, or other data-transmission approaches.

In operation, the computer system 500 may implement the functionality described herein as a result of the processor executing code. Such code may be read from or stored on a non-transitory computer-readable medium, such as memory 510, ROM 508, or storage device 506. Other forms of non-transitory computer-readable media include disks, tapes, magnetic media, CD-ROMs, optical media, RAM, PROM, EPROM, and EEPROM. Any other non-transitory computer-readable medium may be employed. Executing code may also be read from network link 518 (e.g., following storage in an interface buffer, local memory, or other circuitry).

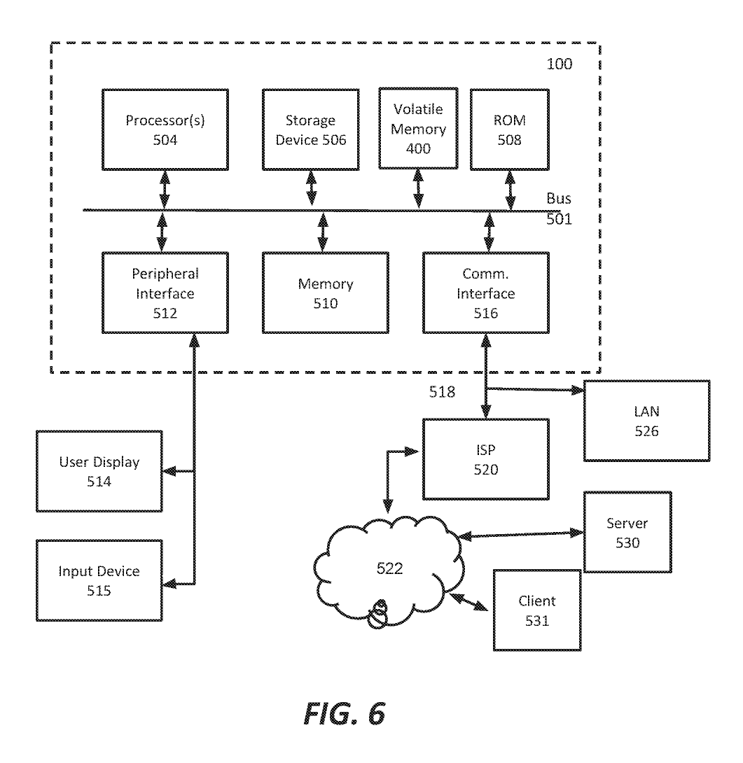

FIG. 6 shows computer system 100 similarly to FIG. 5, but using the alternate embodiment (shown and described with respect to FIG. 4) that omits the FPGA from the tamper response circuitry.

It should be understood that the foregoing has presented certain embodiments of the invention that should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that trademarks appearing herein are the property of their respective owners and used for identification and descriptive purposes only, given the nature of the subject matter at issue, and not to imply endorsement or affiliation in any way.

1. A method for configuring each of a plurality of programmable logic devices with a configuration comprising a common set of data and a unique set of data, where the unique set of data is small relative to the overall size of the configuration, the method comprising:
with one or more provisioning servers:
receiving a configuration file comprising a first set of data and a second set of data, the first set of data being designated as a common set of data;
for a first programmable logic device:
generating a first copy of the configuration file, and modifying the second set of data to include a first authentication key that will be unique to a first programmable logic device, while retaining the common set of data;
storing the first copy of the configuration file into a database for subsequent transmission to a first memory device associated with the first programmable logic device;
for a second programmable logic device:
generating a second copy of the configuration file, and modifying the second set of data to include a second authentication key that will be unique to a second programmable logic device, while retaining the common set of data;
storing the second copy of the configuration file into the database for subsequent transmission to a second memory device associated with the second programmable logic device.

2. The method of claim 1, wherein the second set of data configures a portion of the first programmable logic device as a random access memory.

3. The method of claim 2, wherein the modification to the second set of data stores the first authentication key value in the random access memory.

4. The method of claim 1, wherein the second set of data configures a portion of the second programmable logic device as a random access memory.

5. The method of claim 4, wherein the modification to the second set of data stores the second authentication key value in the random access memory.

6. The method of claim 1, wherein the common set of data in the configuration file is encrypted according to an encryption key, and the first authentication key is also encrypted according to the encryption key.

7. The method of claim 1, wherein the configuration file is encrypted according to an encryption key that the provisioning server stores in the first programmable logic device.

8. The method of claim 1, wherein the first and second programmable logic devices each comprise a field programmable gate array (FPGA).

9. The method of claim 8, wherein the first memory device associated with the first programmable logic device comprises a non-volatile memory device external to the first programmable logic device.

10. The method of claim 1, wherein the configuration files comprises a third set of data that is designated as common data, the configuration file including instructions to select between loading of the first and second configuration images in response to one or more events.

11. A system for configuring each of a plurality of programmable logic devices with a configuration comprising a common set of data and a unique set of data, where the unique set of data is small relative to the overall size of the configuration, the system comprising:
one or more provisioning servers that include circuitry providing one or more processors and one or more memory devices storing computer program instructions for operating the provisioning server to:
A. at a first time during a provisioning process:
receive, from a programmable logic device design tool, a configuration file comprising a first set of data and a second set of data, the first set of data being designated as a common set of data;
for a first programmable logic device:
generating a first copy of the configuration file, and modifying the second set of data to include a first authentication key unique to a first programmable logic device, while retaining the common set of data;
storing the first copy of the configuration file into a database in association with the first authentication key;
for a second programmable logic device:
generating a second copy of the configuration file, and modifying the second set of data to include a second authentication key unique to a second programmable logic device, while retaining the common set of data;
storing the second copy of the configuration file into the database in association with the second authentication key;
B. at a second time during the provisioning process, after the first time;
the database transmitting the first copy of the configuration file for use in configuring a first programmable logic device;
the database transmitting the second copy of the configuration file for use in configuring a second programmable logic device.

12. The system of claim 11, further comprising the a network operations center retrieving information from the database to authenticate one or more computers manufactured in accord with the provisioning process.

13. The system of claim 11, wherein the second set of data configures a portion of the first programmable logic device as a random access memory.

14. The method of claim 13, wherein the modification to the second set of data stores the first authentication key value in the random access memory.

15. The method of claim 11, wherein the second set of data configures a portion of the second programmable logic device as a random access memory.

16. The method of claim 15, wherein the modification to the second set of data stores the second authentication key value in the random access memory.

17. The system of claim 11, wherein the common set of data in the configuration file is encrypted according to an encryption key, and the first authentication key is also encrypted according to the encryption key.

18. The system of claim 11, wherein the configuration file is encrypted according to an encryption key that the provisioning server stores in the first programmable logic device.

19. The system of claim 11, wherein the first and second programmable logic devices each comprise a field programmable gate array (FPGA).
